(19) United States
(12) Patent Application Publication
(10) Pub. No.: US 2026/0016625 A1
(43) Pub. Date: Jan. 15, 2026

(54) BACKLIGHT KIT

(71) Applicant: Primax Electronics Ltd.

(72) Inventors: Chia-Ming Li, Taipei (TW); Ming-Hui Yeh, Taipei (TW); Ruey-Piin Wang, Taipei (TW); Jia-Hung Lin, Taipei (TW)

(21) Appl. No.: 18/795,633

(22) Filed: Aug. 6, 2024

(30) Foreign Application Priority Data
Jul. 12, 2024 (TW) 113126332

(51) Int. Cl. F21V 8/00

(52) U.S. Cl. CPC G02B 6/0051; G02B 6/0068

(57) ABSTRACT

A backlight kit includes a base member, a light diffusion covering member, a light guide module, an illumination module and a translucent black gradient light-transmissible element. The illumination module, the light guide module and a translucent black gradient light-transmissible element are disposed within an accommodation space that is defined by the base member and the light diffusion covering member. The translucent black gradient light-transmissible element is arranged between the light guide module and the light diffusion covering member. Due to the arrangement of the translucent black gradient light-transmissible element, a smooth and luminance-gradient visual effect is produced on the light diffusion covering member.

### FIELD OF THE INVENTION

The present invention relates to a light source structure, and more particularly to a backlight kit for an electronic device.

### BACKGROUND OF THE INVENTION

As known, a light emitting diode (LED) has the characteristics of small size, low power consumption, long life and quick operation response. Consequently, LEDs have been widely applied to the backlight sources of sign lights, advertising lights, vehicle light sources, motorcycle light sources, outdoor/indoor lighting devices, monitors or computer peripherals.

In today's society, electronic devices have become daily necessities for life. Due to diverse types of electronic devices, the competitive pressure of similar categories of products is also increasing. In order to make the produced electronic devices more recognizable, LED light sources are usually installed in electronic devices. Due to the arrangement of the LED light source, the electronic device can produce a special luminous visual effect. The luminous visual effect can attract the consumers' attention. In addition, the installation of the LED light source increases the convenience of using the electronic device. Consequently, the electronic devices can gain the favor of consumers and enhance their buying willingness.

FIG. 1 is a schematic perspective view illustrating a portion of the structure of a conventional backlight kit. The conventional backlight kit 90 is designed according to a backlight technology of producing a luminance-gradient visual effect. As shown in FIG. 1, the conventional backlight kit 90 comprises a base member 91, a light guide element 92, an illumination module 93 and a covering member 94. The base member 91 includes a concave structure 911. A surface of the light guide element 92 is provided with a light diffusion structure region 921 and a recess 922. The illumination module 93 includes a circuit board 931 and at least one light-emitting unit 932. The covering member 94 includes a light diffusion wall 941 that can diffuse light. At least one light guide block 9411 is inwardly from a side of the light diffusion wall 941 close to the base member 91. The illumination module 93 is attached on a surface of the light guide element 92 through the circuit board 931. In addition, the at least one light-emitting unit 932 is disposed within the recess 922.

The light-emitting unit 932 emits a light beam toward the light guide element 92. In addition, the light beam is transferred within the light guide element 92. Then, the light beam is diffused from the light diffusion structure area 921 and the light guide block 9411 near the end of the light guide element 92 to the light diffusion wall 941. Consequently, the surface of the light diffusion wall 941 produces a special optical visual effect. In accordance with this conventional technology, the region of the light diffusion wall 941 corresponding to the illumination module 93 is defined as a first luminous region B1, and the region corresponding to the light diffusion structure region 921 is defined as a second luminous region B2.

Please continue to refer to FIGS. 2A and 2B. FIG. 2A and FIG. 2B schematically illustrate the luminance-gradient visual effect produced by the conventional backlight kit.

In the situation of FIG. 2A, the illumination module 93 shown in FIG. 1 is not activated. Under this circumstance, an obvious black and white discontinuity interface is formed between the first luminous region B1 and the second luminous region B2 on the light diffusion structure region 921.

In the situation of FIG. 2B, the illumination module 93 is activated. Under this circumstance, the obvious black and white discontinuity interface is also formed between the first luminous region B1 and the second luminous region B2 on the light diffusion structure region 921. Furthermore, the light diffusion structure region 921 with gradually dense dots in the second luminous region B2 and the edge bright lines formed by the diffused light from the light guide block 9411 can also be clearly and visually observed. Consequently, the backlight kit 90 is unable to produce the smooth luminance-gradient visual effect on the light diffusion wall 941.

In order to overcome the drawbacks of the conventional technologies, it is important to provide a backlight kit with a function of producing a smooth and luminance-gradient visual effect.

### SUMMARY OF THE INVENTION

The present invention provides backlight kit with a function of producing a smooth and luminance-gradient visual effect.

In accordance with an aspect of the present invention, a backlight kit is provided. The backlight kit includes a base member, a light diffusion covering member, a light guide module, an illumination module and a translucent black gradient light-transmissible element. The base member includes a concave structure. The light diffusion covering member is combined with the base member. The base member is covered by the light diffusion covering member. The light guide module is disposed within the concave structure of the base member. The light guide module has a light diffusion structure region facing the light diffusion covering member. The light diffusion structure region has light diffusion microstructures that are distributed from sparse to dense. The illumination module is located beside a side of the light guide module away from the light diffusion structure region. The illumination module emits a light beam to the light guide module. The light beam is exited from the light diffusion structure region. The translucent black gradient light-transmissible element is arranged between the light guide module and the light diffusion covering member. The translucent black gradient light-transmissible element includes a first opaque black ink layer, a sharp gradient light-transmissible black ink layer and a smooth gradient light-transmissible black ink layer. The sharp gradient light-transmissible black ink layer is arranged between the first opaque black ink layer and the smooth gradient light-transmissible black ink layer. A width of the sharp gradient light-transmissible black ink layer is smaller than a width of the smooth gradient light-transmissible black ink layer. The first opaque black ink layer is aligned with the illumination module. The sharp gradient light-transmissible black ink layer and the smooth gradient light-transmissible black ink layer are aligned with the light diffusion structure region. After the light beam is exited from the light diffusion structure region, the light beam is transmitted through the sharp gradient light-transmissible black ink layer and the smooth gradient light-transmissible black ink layer, so that a smooth and luminance-gradient visual effect is produced on the light diffusion covering member.

In an embodiment, a transmittance of the sharp gradient light-transmissible black ink layer is gradually changed from 0% to 50% in a direction from the first opaque black ink layer to the smooth gradient light-transmissible black ink layer.

In an embodiment, a width of the sharp gradient light-transmissible black ink layer is in a range between 3 mm and 5 mm.

In an embodiment, a transmittance of the smooth gradient light-transmissible black ink layer is gradually changed from 50% to 100% in a direction from a side near the sharp gradient light-transmissible black ink layer to a side away from the sharp gradient light-transmissible black ink layer.

In an embodiment, a width of the smooth gradient light-transmissible black ink layer is at least 10 mm.

In an embodiment, the translucent black gradient light-transmissible element further comprises a second opaque black ink layer, and the second opaque black ink layer is located beside a side of the smooth gradient light-transmissible black ink layer away from the sharp gradient light-transmissible black ink layer.

In an embodiment, a width of the second opaque black ink layer is at least 1 mm.

In an embodiment, a thickness of the translucent black gradient light-transmissible element is less than 0.2 mm.

In an embodiment, the translucent black gradient light-transmissible element is formed by using a digital spraying process or a lithography process.

In an embodiment, the translucent black gradient light-transmissible element is made of plastic material or glass material.

In an embodiment, the illumination module includes a circuit board, a light-shielding plate and at least one light-emitting unit. The at least one light-emitting unit is disposed on a first surface of the circuit board and emits the light beam to the light guide module. The light-shielding plate is disposed on a second surface of the circuit board. The first surface and the second surface of the circuit board are opposed to each other.

In an embodiment, the light-emitting unit is a light emitting diode unit, an organic light emitting diode unit, a quantum dots light emitting diode unit or an electroluminescence unit.

In an embodiment, the light guide module comprises a light guide plate, and the light diffusion structure region is formed on a surface of the light guide plate.

In an embodiment, a reflective film is formed on a second surface of the light guide plate. The first surface and the second surface of the light guide plate are opposed to each other.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a portion of the structure of a conventional backlight kit;

FIG. 2A and FIG. 2B schematically illustrate the luminance-gradient visual effect produced by the conventional backlight kit;

FIG. 3A is a schematic exploded view illustrating a backlight kit according to an embodiment of the present invention;

FIG. 3B is a schematic cross-sectional view illustrating the backlight kit according to the embodiment of the present invention;

FIG. 4 is a schematic top view illustrating the translucent black gradient light-transmissible element used in the backlight kit of the present invention; and

FIGS. 5A and 5B schematically illustrate the luminance-gradient visual effect produced by the backlight kit according to the embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

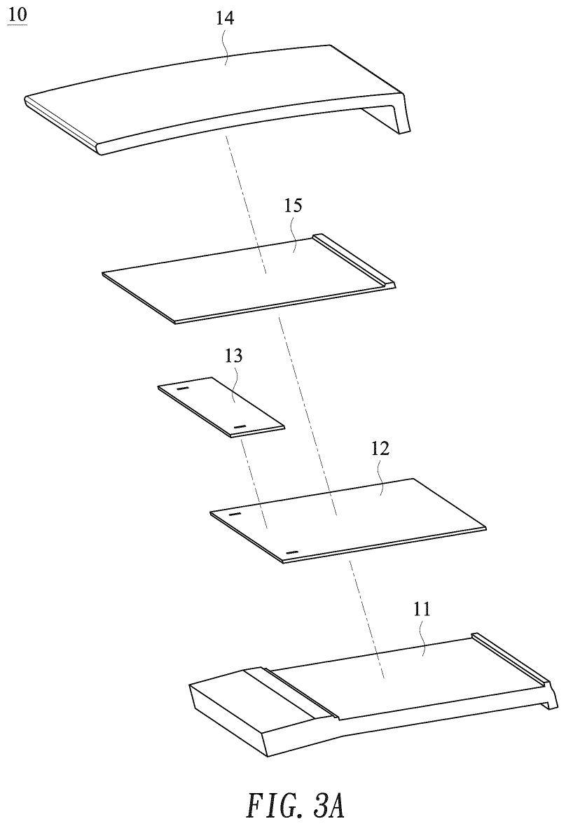

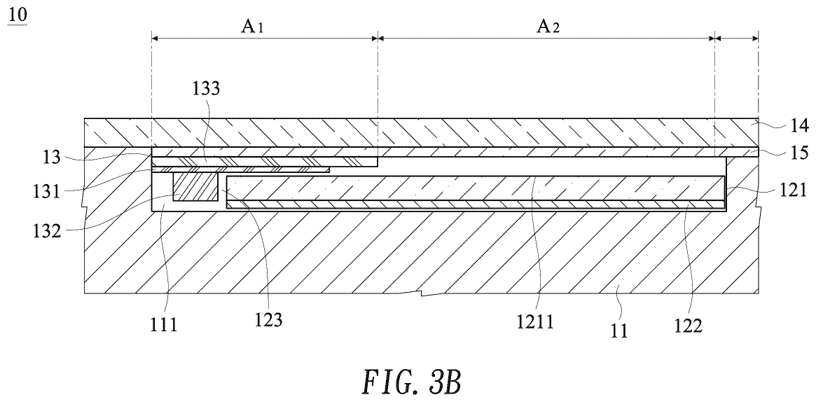

Please refer to FIG. 3A and FIG. 3B. FIG. 3A is a schematic exploded view illustrating a backlight kit according to an embodiment of the present invention. FIG. 3B is a schematic cross-sectional view illustrating the backlight kit according to the embodiment of the present invention. The backlight kit 1 of the present invention can be installed on a housing of a peripheral connection port of an electronic device. Furthermore, the backlight kit 1 can produce a luminance-gradient visual effect to prompt the user to know the position of the peripheral connection port or the usage status of the peripheral connection port.

In this embodiment, the backlight kit 1 includes a base member 11, a light guide module 12, an illumination module 13, a light diffusion covering member 14 and a translucent black gradient light-transmissible element 15.

The base member 11 includes a concave structure 111. The light guide module 12 includes a light guide plate 121, a reflective film 122 and a recess 123. A surface of the light guide plate 121 away from the recess 123 is provided with a light diffusion structure region 1211. In this embodiment, the light diffusion structure region 1211 also has light diffusion microstructures (not shown). These light diffusion microstructures are distributed from sparse to dense.

The illumination module 13 includes a circuit board 131, one or more light-emitting units 132 and a light-shielding plate 133. The plural light-emitting units 132 are disposed on a first surface of the circuit board 131. The light-shielding plate 133 is disposed on a second surface of the circuit board 131. The first surface and the second surface of the circuit board 131 are opposed to each other. For example, the light-emitting units 132 are light emitting diode (LED) units, organic light emitting diode (OLED) units, quantum dots light emitting diode (QLED) units or electroluminescence (EL) units.

Please refer to FIG. 3B again. The light guide module 12 is disposed within the concave structure 111 of the base member 11. The illumination module 13 is located beside a side of the light guide module 12 away from the light diffusion structure region 1211. In an embodiment, the illumination module 13 is attached on the light guide plate 121 through the circuit board 131. In addition, the light-emitting units 132 are correspondingly accommodated within the recess 123 of the light guide module 12. In some other embodiments, the size of the light guide plate 121 of the light guide module 12 is smaller than the concave structure 111 of the base member 11, and an avoidance space is formed in a side of the concave structure 111 for accommodating the light-emitting units 132. In other words, the recess 123 of the light guide module 12 may be omitted.

In an embodiment, the translucent black gradient light-transmissible element 15 is located over the illumination module 13 and arranged between the light guide module 12 and the light diffusion covering member 14. The light diffusion covering member 14 and the base member 11 are combined together, and thus the concave structure 111 is covered. In an embodiment, the light diffusion structure region 1211 of the light guide module 12 faces the translucent black gradient light-transmissible element 15 and also faces the light diffusion covering member 14. Due to the illumination module 13 and the light diffusion structure region 1211 of the light guide module 12, a first luminous region A1 and a second luminous region A2 on the surface of the light diffusion covering member 14 are defined.

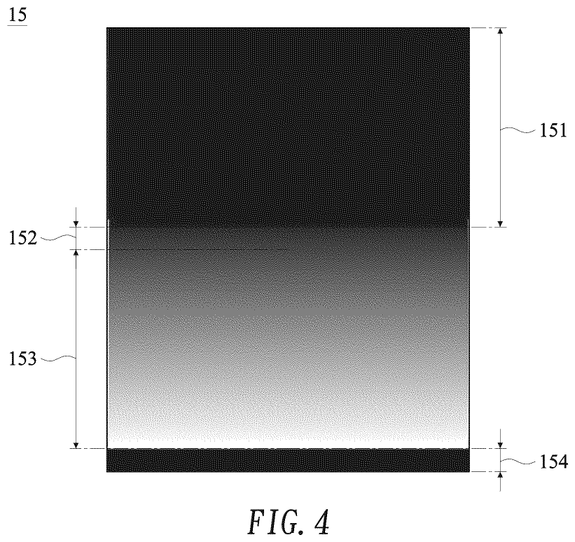

Please refer to FIG. 4. FIG. 4 is a schematic top view illustrating the translucent black gradient light-transmissible element used in the backlight kit of the present invention. From top to bottom, the translucent black gradient light-transmissible element 15 includes a first opaque black ink layer 151, a sharp gradient light-transmissible black ink layer 152, a smooth gradient light-transmissible black ink layer 153 and a second opaque black ink layer 154. The sharp gradient light-transmissible black ink layer 152 is arranged between the first opaque black ink layer 151 and the smooth gradient light-transmissible black ink layer 153. The width of the sharp gradient light-transmissible black ink layer 152 is smaller than the width of the smooth gradient light-transmissible black ink layer 153. The second opaque black ink layer 154 is located beside a side of the smooth gradient light-transmissible black ink layer 153 away from the sharp gradient light-transmissible black ink layer 152. In an embodiment, the translucent black gradient light-transmissible element 15 is formed by using a digital spraying process or a lithography process. Preferably but not exclusively, the translucent black gradient light-transmissible element 15 is made of plastic material (e.g., PET, PMMA or PC) or glass material. The overall thickness of the translucent black gradient light-transmissible element 15 is less than 0.2 mm.

The first opaque black ink layer 151 is aligned with the illumination module 13 (i.e., the first luminous region A1 as shown in FIG. 3B) to cover the illumination module 13. The sharp gradient light-transmissible black ink layer 152 and the smooth gradient light-transmissible black ink layer 153 are aligned with the light diffusion structure region 1211 (i.e., the second luminous region A2). The sharp gradient light-transmissible black ink layer 152 is aligned with the interface between the first luminous region A1 and the second luminous region A2.

The transmittance of each of the first opaque black ink layer 151 and the second opaque black ink layer 154 is 0%. The width of the first opaque black ink layer 151 may be adjusted according to the size of the illumination module 13. That is, the width range of the first opaque black ink layer 151 is not restricted. Preferably, the width of the second opaque black ink layer 154 is at least 1 mm.

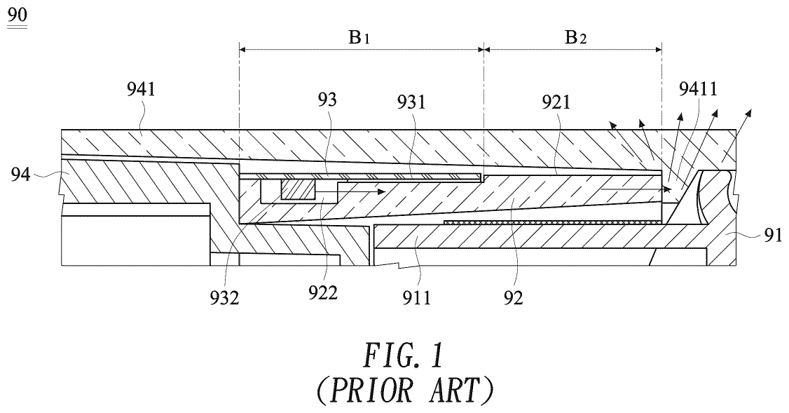

It is noted that numerous modifications and variations may be made while retaining the teachings of the present invention. For example, in some other embodiments, the end of the second luminous region A2 away from the first luminous region A1 is not equipped with the light guide block that is described in the conventional technology of FIG. 1 or is not equipped with a light diffusion gap. Under this circumstance, the second opaque black ink layer 154 of the translucent black gradient light-transmissible element 15 is omitted.

The transmittance of the sharp gradient light-transmissible black ink layer 152 is gradually changed from 0% to 50% in the direction from the first opaque black ink layer 151 to the smooth gradient light-transmissible black ink layer 153. In an embodiment, the width of the sharp gradient light-transmissible black ink layer 152 is in the range between 3 mm and 5 mm.

The transmittance of the smooth gradient light-transmissible black ink layer 153 is gradually changed from 50% to 100% in the direction from the side near the sharp gradient light-transmissible black ink layer 152 to the side away from the sharp gradient light-transmissible black ink layer 152. In an embodiment, the width of the smooth gradient light-transmissible black ink layer 153 is at least 10 mm.

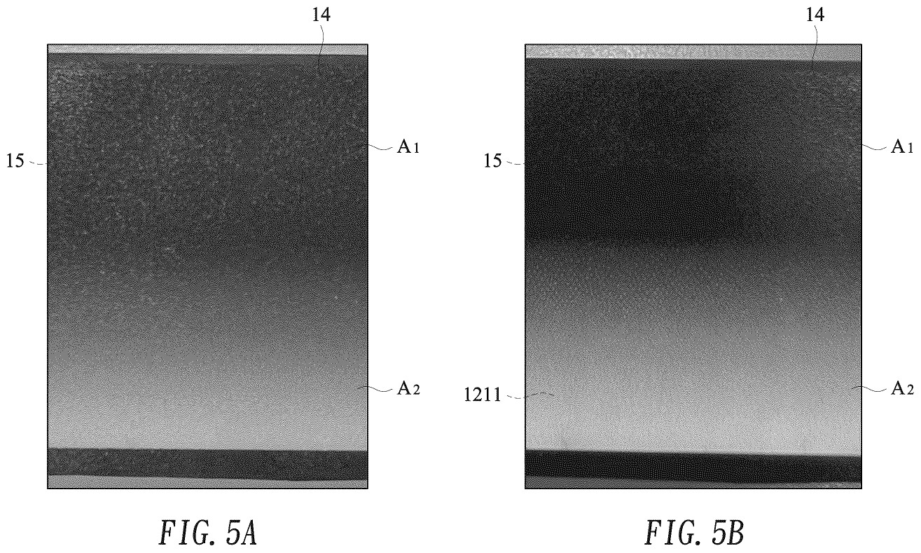

Please refer to FG. 3B, FIG. 4, FIG. 5A and FIG. 5B. FIGS. 5A and 5B schematically illustrate the luminance-gradient visual effect produced by the backlight kit according to the embodiment of the present invention.

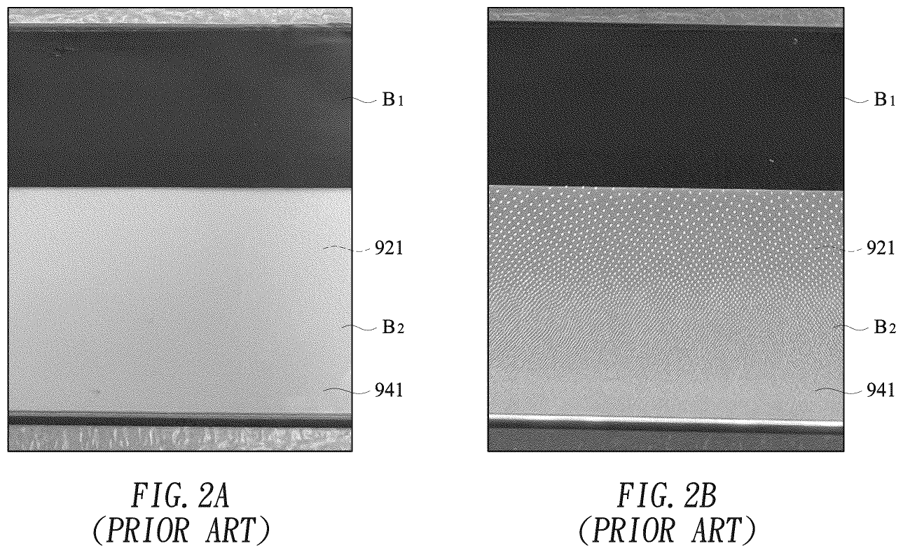

In the situation of FIG. 5A, the illumination module 13 is not activated. In accordance with the backlight kit 10 of the present invention, the obvious black and white discontinuity interface between the first luminous region A1 and the second luminous region A2 shown in FIGS. 3B and 5A is initially alleviated through the sharp gradient light-transmissible black ink layer 152, and then the smooth luminance-gradient visual effect is formed on the light diffusion covering member 14 through the subsequent smooth gradient light-transmissible black ink layer 153. In other words, the backlight kit 10 of the present invention can overcome the drawbacks of the conventional backlight kit shown in FIG. 2A.

Please refer to FIGS. 3B and 5B. The illumination module 13 is activated. The light-emitting unit 132 emits a light beam toward the light guide module 12 and transfers the light beam in the light guide module 12. Due to the arrangement of the reflective film 122, the light transmission efficiency is further enhanced. After the light beam is exited from the light diffusion structure region 1211, the light beam is transmitted to the light diffusion covering member 14 through the translucent black gradient light-transmissible element 15.

Furthermore, in case that a portion of the light beam transmitted through the light guide module 12 is exited from the first luminous region A1 early, the leaked light beam can be blocked by the light-shielding plate 133 of the illumination module 13 and the first opaque black ink layer 151 of the translucent black gradient light-transmissible element 15. Consequently, the first luminous region A1 is maintained in the completely dark state. In some embodiments, the leaked light beam is completely blocked by the first opaque black ink layer 151 of the translucent black gradient light-transmissible element 15. In other words, the light-shielding plate 133 of the illumination module 13 can be omitted.

After the light beam is exited from the light diffusion structure region 1211, the light beam is transmitted through the sharp gradient light-transmissible black ink layer 152 and the smooth gradient light-transmissible black ink layer 153 of the translucent black gradient light-transmissible element 15. Consequently, a smooth and luminance-gradient visual effect can be produced on the light diffusion covering member 14. As mentioned above, the uses of the sharp gradient light-transmissible black ink layer 152 and the smooth gradient light-transmissible black ink layer 153 make the luminance-gradient visual effect smoother. Also, the sharp gradient light-transmissible black ink layer 152 and the smooth gradient light-transmissible black ink layer 153 can further shelter the light diffusion structure region 1211. Since the second luminous region A2 corresponding to the light diffusion structure region 1211 is sheltered by the translucent black gradient light-transmissible element 15, the user cannot visually observe the dot structures or their noise points on the light diffusion structure region 1211. Consequently, the luminance-gradient visual effect and the visual comfortable efficacy will be enhanced.

Obviously, as shown in FIGS. 5A and 5B, the second opaque black ink layer 154 (see FIG. 4) can completely shelter the bottom edge bright line of the superficial luminance-gradient visual effect.

In the above embodiment, the translucent black gradient light-transmissible element 15 is arranged between the light guide module 12 and the light diffusion covering member 14. It is noted that numerous modifications and variations may be made while retaining the teachings of the present invention. For example, in another embodiment, the translucent black gradient light-transmissible element 15 is combined with the inner surface of the light diffusion covering member 14. Alternatively, the plural ink layers of the translucent black gradient light-transmissible element 15 are directly printed on the inner surface of the light diffusion covering member 14.

From the above descriptions, the present invention provides the backlight kit. Different ink layers of the translucent black gradient light-transmissible element have different transmittances to produce different shielding effects. Consequently, regardless of whether the illumination module is turned on or turned off, the obvious black and white discontinuity interface between the adjacent luminous regions will not be generated. Furthermore, when the illumination module is activated, the luminous region corresponding to the light diffusion structure region of the light guide module is sheltered by the translucent black gradient light-transmissible element. Since the user cannot visually observe the dot structures or their uniform noise points on the light diffusion structure region, the smooth and luminance-gradient visual effect can be produced on the surface of the backlight kit. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

1. A backlight kit, comprising:
a base member comprising a concave structure;
a light diffusion covering member combined with the base member, wherein the base member is covered by the light diffusion covering member;
a light guide module disposed within the concave structure of the base member, wherein the light guide module has a light diffusion structure region facing the light diffusion covering member, and the light diffusion structure region has light diffusion microstructures that are distributed from sparse to dense;
an illumination module located beside a side of the light guide module away from the light diffusion structure region, wherein the illumination module emits a light beam to the light guide module, the illumination module comprises a circuit board, a light-shielding plate and at least one light-emitting unit, wherein the at least one light-emitting unit is disposed on a first surface of the circuit board and emits the light beam to the light guide module, and the light-shielding plate is disposed on a second surface of the circuit board, wherein the first surface and the second surface of the circuit board are opposed to each other; and
a translucent black gradient light-transmissible element located over illumination module and arranged between the light guide module and the light diffusion covering member,
wherein the translucent black gradient light-transmissible element comprises a first opaque black ink layer, a sharp gradient light-transmissible black ink layer and a smooth gradient light-transmissible black ink layer, wherein the sharp gradient light-transmissible black ink layer is arranged between the first opaque black ink layer and the smooth gradient light-transmissible black ink layer, a width of the sharp gradient light-transmissible black ink layer is smaller than a width of the smooth gradient light-transmissible black ink layer, the first opaque black ink layer is aligned with the illumination module, and the sharp gradient light-transmissible black ink layer and the smooth gradient light-transmissible black ink layer are aligned with the light diffusion structure region,
wherein a transmittance of the sharp gradient light-transmissible black ink layer is gradually changed from 0% to 50% in a direction from the first opaque black ink layer to the smooth gradient light-transmissible black ink layer,
wherein a transmittance of the smooth gradient light-transmissible black ink layer is gradually changed from 50% to 100% in a direction from a side near the sharp gradient light-transmissible black ink layer to a side away from the sharp gradient light-transmissible black ink layer
wherein after the light beam is exited from the light diffusion structure region, the light beam is transmitted through the sharp gradient light-transmissible black ink layer and the smooth gradient light-transmissible black ink layer, so that a smooth and luminance-gradient visual effect is produced on the light diffusion covering member.

2. (canceled)

3. The backlight kit according to claim 1, wherein a width of the sharp gradient light-transmissible black ink layer is in a range between 3 mm and 5 mm.

4. (canceled)

5. The backlight kit according to claim 1, wherein a width of the smooth gradient light-transmissible black ink layer is at least 10 mm.

6. The backlight kit according to claim 1, wherein the translucent black gradient light-transmissible element further comprises a second opaque black ink layer, and the second opaque black ink layer is located beside a side of the smooth gradient light-transmissible black ink layer away from the sharp gradient light-transmissible black ink layer.

7. The backlight kit according to claim 6, wherein a width of the second opaque black ink layer is at least 1 mm.

8. The backlight kit according to claim 1, wherein a thickness of the translucent black gradient light-transmissible element is less than 0.2 mm.

9. The backlight kit according to claim 1, wherein the translucent black gradient light-transmissible element is formed by using a digital spraying process or a lithography process.

10. The backlight kit according to claim 9, wherein the translucent black gradient light-transmissible element is made of plastic material or glass material.

11. (canceled)

12. The backlight kit according to claim 1, wherein the light-emitting unit is a light emitting diode unit, an organic light emitting diode unit, a quantum dots light emitting diode unit or an electroluminescence unit.

13. The backlight kit according to claim 1, wherein the light guide module comprises a light guide plate, and the light diffusion structure region is formed on a surface of the light guide plate.

14. The backlight kit according to claim 13, wherein a reflective film is formed on a second surface of the light guide plate, wherein the first surface and the second surface of the light guide plate are opposed to each other.
